(19) United States
(12) Patent Application Publication
(10) Pub. No.: US 2011/0231344 A1
(43) Pub. Date: Sep. 22, 2011

(54) Continuous Gift Card

(76) Inventor: Paul Hall, Dublin, OH (US)

(21) Appl. No.: 12/727,879

(22) Filed: Mar. 19, 2010

(51) Int. Cl. G06Q 90/00

(52) U.S. Cl. 705/500

(57) ABSTRACT

A method of providing a gift card having a value to a user, comprising determining the products or services to be included, determining terms, determining a value for the products or services, determining whether to allow the user to use all of the offer, specifying a selection of the products or services available, aggregating the maximum total value of the offer; preparing the card, the card have a listing of the products and services, the selection of the products or services available, and the maximum total value of the offer, and sending the card to the user. The user selects choices from the selection of the products or services in the offer up to the maximum total value of the offer.

### FIELD OF THE INVENTION

The present invention relates generally to gift cards, and specifically to gift cards given away or sold for a dramatically reduced price to encourage the recipient to purchase the products and/or services of a company.

### BACKGROUND OF THE INVENTION

It is a problem to get consumers to try products and services of a business. One way to get them to try or re-try a product or service is to give them or sell to them at a reduced price a purchase value, such as a Gift Card.

The difficulty with giving consumers a simple Gift Card is that they might try the businesses products and/or services only once. However, the challenge is how to get them to know about the multiple products and/or services of the business and to come back in and try several of these products and/or services, so they become regular customers.

As a provider of marketing services, the challenge is how to drive, and show a business that you are driving in, repeat purchases, not just a simple one-time trial from a customer who may not have a reason to come back.

There is a long-standing need for a way to drive enough initial experiences from new customers to get them to be regular customers. And, to be able to track who is responding to your purchase value Gift Cards, and how many times.

An ideal system would provide a way to show consumers (and potential customers) the several products and/or services that a business offers, give them a purchase value for one or more purchases of those services, demonstrating a high total purchase value gift, thereby motivating repeat visits and purchases, beyond the purchase value itself. Such a multiple product/service purchase Gift Card would go beyond a single “trial” purchase experience, and make it more likely that the consumers would see a higher value to come in and try a businesses products/services over multiple occasions or multiple types of products. Additional such a bifurcated purchase value Gift Card could be used to show a large purchase value across multiple businesses.

The present invention addressed the above-described problems by constructing multiple purchase values for different products and services (high value “trial” purchase values, “repeat” or subsequent “return” purchase values, multi-department purchase value choices or “cross-sell” purchase values to motivate purchase experiences with multiple types of the business' products and/or services). The present invention generally accumulates the individual purchase values into a larger total Gift Card value that suggests or even requires multiple purchase visits. Alternately, when the purchase values are already high enough on the individual items listed, the present invention offers the gift card recipient the choice of item(s) they want to purchase, for one or a specified number of items at specified purchase values that could total up to a purchase “face value” on the Gift Card.

### BRIEF DESCRIPTION OF THE INVENTION

The present invention is a method for providing a gift card having a value to a user, the method comprising:
a) determining at least one product or service of a merchant to be included in an offer to the user;
b) determining terms for each product or service in the offer;
c) determining a value for each product or service in the offer;
d) determining whether to allow the user to use all of the products or services in the offer;
e) specifying a selection of the products or services in the offer available for user by the user;
f) aggregating the maximum total value of the offer;
g) preparing the card, the card comprising: i) a listing of the products and services in the offer, ii) the selection of the products or services in the offer available for user, and iii) the maximum total value of the offer; and
h) sending the card to the user, wherein the user selects choices from the selection of the products or services in the offer up to the maximum total value of the offer.

The card system comprises an offer to a user where at least one of the products or services in the offer has a high value and the other products or services are one of new or lower value than the first product/service. The card system comprises a combination of products and or services and can contain offers from more than one merchant. In an embodiment, the user is permitted to choose one product /service from the offer.

In an embodiment, the offer is a digital offer and comprises an electronic display that indicates a) a listing of products and services in the offer, and b) the aggregated value of the offer. When the card is used, the aggregated value displayed is decreased by the value of the product/service selected by the user.

The card of the system comprises i) a listing of products and services offered by a merchant under terms, ii) a selection of the products or services in the offer available to a user, and iii) a maximum total value of the offer. A user, when using the card, selects choices from the selection of the products or services in the offer up to the maximum total value of the offer. At least one of the products or services in the offer has a high value and the other products or services are one of new or lower value than the first product/service.

In an embodiment, the offer comprises a combination of products/services, the card contains offers from more than one merchant, and the user is permitted to choose one product or service from the offer.

In an embodiment the card is digital and comprises an electronic display that indicates a) a listing of products and services in the offer, and b) the aggregated value of the offer, and when the card is used, the aggregated value displayed is decreased by the value of the product/service selected by the user.

As used herein, “approximately” means within plus or minus 25% of the term it qualifies. The term “about” means between ½ and 2 times the term it qualifies. The term “substantially” means that ninety-five percent of the values of the physical property when measured along an axis of, or within a plane of or within a volume of the structure, as the case may be, will be within plus or minus 10% of a mean value.

As used herein, the term “gift card” may be broadly construed to mean a conventional gift card as well as any other promotion, coupon, discount offer, grant, certificate, or the like in physical or digital form. The methods of the present invention can comprise, consist of, or consist essentially of the essential elements and limitations of the invention described herein, as well as any additional or optional components, or limitations described herein or otherwise useful in compositions and methods of the general type as described herein.

All references to singular characteristics or limitations of the present invention shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

### BRIEF DESCRIPTION OF THE DRAWINGS

FIG. 1 is flow chart of the steps of an embodiment of the invention.

FIG. 2 is a example depiction of a front and back of a generalized version of an embodiment of the card of the present invention.

FIG. 3 is a example depiction of the front and back of a specific version of an embodiment of the card of the present invention.

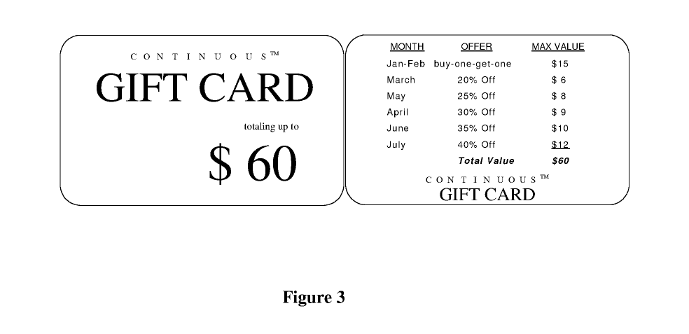

FIG. 4 is an alternate embodiment of the back of a specific version of the card present invention.

FIG. 5 is an alternate embodiment of the back of the card present invention.

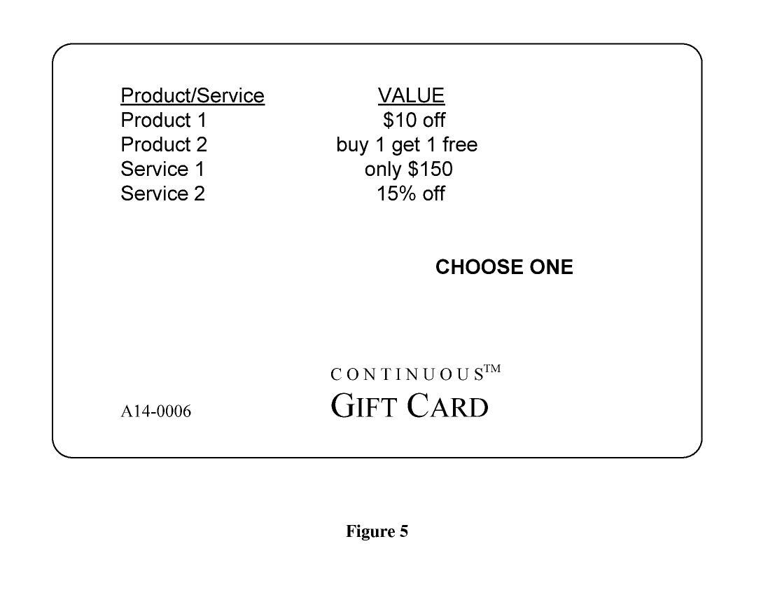

### DETAILED DESCRIPTION OF THE INVENTION

As shown in the Figures and described herein, an embodiment of the present invention comprises a physical card or card image that looks like and is in about the same size and/or shape of a traditional gift card.

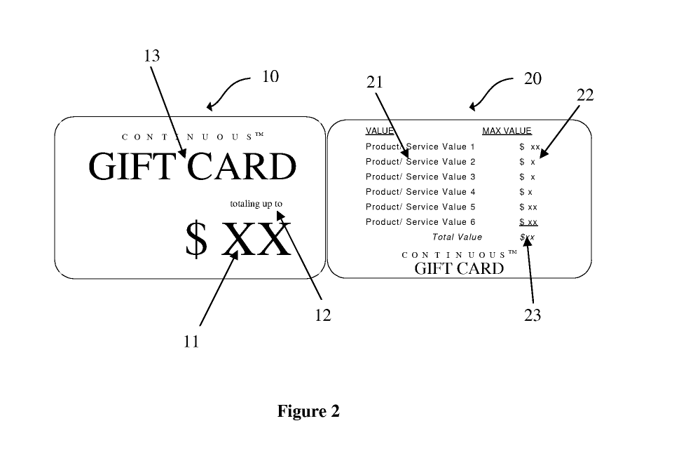

As depicted in FIG. 2, the front of the card 10 component shows the “face value” or maximum total potential purchase value of the card 11, accompanied by the phrase “up to” or “totaling up to” 12. The front of the card also has the label of “Continuous™ Gift Card” 13. The front of the card may also include a logo or other imagery or decoration relating to the company providing the gift card.

The back or reverse side of the card 20 contains a list briefly describing multiple purchase values, including: (a) the products or services to which the purchase value can be applied 21, (b) how it can be applied (e.g. as a specific dollar amount, or as a percentage of the total price) 22, and (c) the maximum purchase value that is being given 23. The back of the card may also include a logo or other imagery or decoration relating to the company providing the gift card.

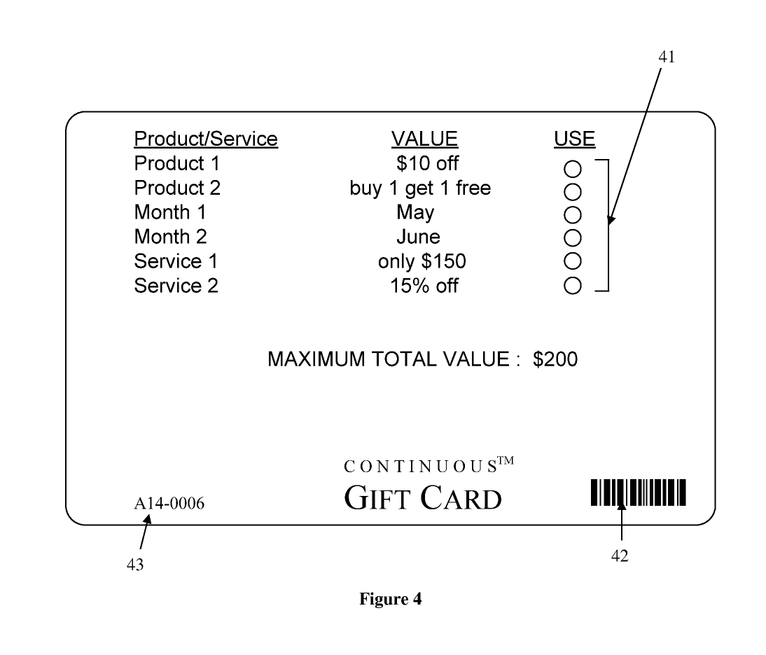

As shown in FIG. 4, alternate components for the back of the card can include: blocks to mark off or punch hole marks for each purchase offer 41, where a business wants to enable the cardholder to use each purchase value only once. The business representative can mark or make a punch hole when the consumer uses a specific purchase value, so that when the cardholder comes in on a subsequent visit, the representative of the business on that visit can tell which offer(s) have already been used.

An optional component for the back of the card is: a bar code 42, alphanumeric code or other code to identify who the card was sent or given to 43. Alternately, the information is contained on a magnetic strip (not shown). By scanning or recording this code along with a coding for the purchase value used, the business can track which consumers have used their cards and for what product/service purchase values.

A wide range of purchase values are used. These can be developed by the business or its agents to encourage the purchase of particular types of products and/or services that may be of more interest to the consumer, and/or more pertinent to the business objectives of the business.

The invention is applicable with particular advantage to businesses who want to: (a) encourage trial of selected products and/or services by new, former or even current customers and (b) make consumers aware of the various types of products and/or services that the business offers, and (c) at the same time encourage multiple visits/purchases. These actions encourage a new customer to become a regular or repeat customer. The invention also provides advantages to consumers in that it is provided at no charge to the consumer. The consumer does not have to make an initial purchase to receive a card.

Typical “trial” generation programs just encourage a single trial purchase, and then hope that the customer comes back in for subsequent purchases. This multiple purchase value program helps address that problem, by encourage consumers to come in for multiple purchases to get more experience with shopping at the business and using its various products and services.

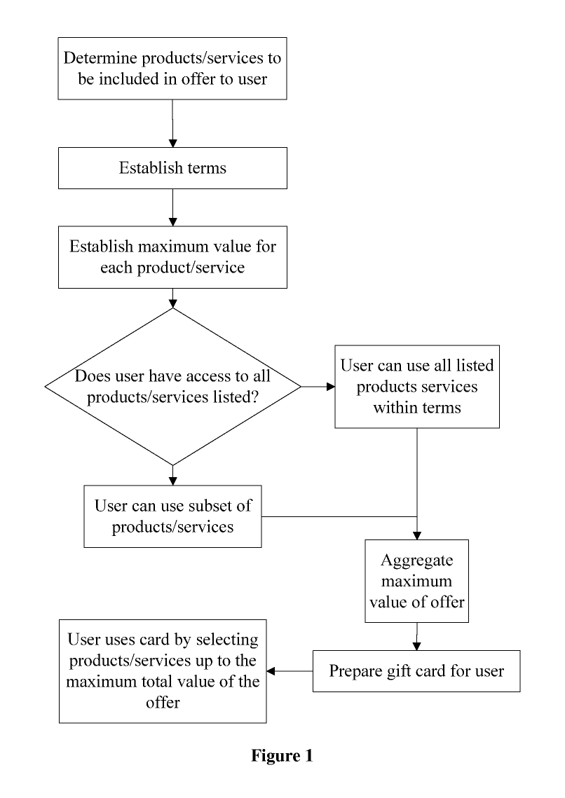

As shown in FIG. 1, the process includes the steps of (a) determining what products and/or services to offer purchase values for, the terms of those purchase values, and the maximum value given, (b) determining whether to give a cardholder all of the purchase values, or let them choose only one or a specified number of the values listed on the card, (c) aggregating the maximum total purchase value being given, and (d) designing a physical gift card and/or electronic card image with these multiple purchase values listed, along with the total maximum aggregate purchase value on the front and/or back of the card.

The method of the invention is applicable to any process for making and distributing a card or card image, providing multiple purchase values and an aggregated total card value and/or the words “gift card”.

The present invention provides the following advantages over typical gift cards:
a way to combine trial programs with ongoing customer development
a way to demonstrate and grow the repeat purchase value of a new customer
potentially can be sent out to consumers for free, and be very high value, compelling calls-to-action to drive traffic in the door and back in the door (high ROI for the merchant)
bringing together promotion with database marketing
enabling extensive analysis with consumer list data on customer acquisition programs
trackability via database marketing software
lets merchants tie gift cards to specific purchase values, rather than just being general cash value for anything in the store
lets the merchant display the range of products and/or services they have available
gives the consumer a card that can be removed and put in their wallet, providing an ongoing mechanism to help keep the business “top of mind” with the consumer.

### Example

A business decides what products or services they want to offer purchase values for, and how much purchase value they want to offer for each item and what the terms will be on the purchase value (e.g. whether the purchase value will be a free item with purchase—e.g. buy-one, get-one, or GWP gift-with-purchase) or a dollar value or percent value, up to a specified maximum amount, etc).

The business decides whether a given purchase value will be restricted to only one use per purchase value (using a mark-off or punch hole to show that the purchase value has been used).

The business decides if they want to give the user permission to use all the items on the list, or only be able to make a choice of only one, or a specified number, of the purchase values listed. In each case, the business then identifies the maximum aggregate purchase value that a gift card could total up to. This “face value” then is shown on the front of the Gift Card, with a clear marking of “up to” or “totaling up to”, so that the recipient clearly sees that their use of the Gift Card could—but may not necessarily—total up to that amount, depending on the purchase values they choose to utilize.

The Continuous Gift Card or card image is about 2 inches high by 3 inches wide or in about this aspect ratio, so as to look like a simple gift card. It may or may not have rounded corners, depending on the print or electronic media and images used. The front of the card is clearly marked with the trademarked name Continuous™ Gift Card. The background color and/or image of both the front and back of the card will vary according to the imagery selected by the business.

On the back of the card, the business lists the product/service items (“Offers”) and the order in which they want them displayed and the maximum purchase value they want to set for each item (“Max Value”). The total maximum purchase values may be shown, on the back to clarify for the card holder how the card “face value” on the front of the card was derived. There may or may not be “punch holes” to the left of the offers. There may or may not be a “bar code” and/or alphanumeric code on the back to the right of the offer Max Value numbers or on the front of the card that may be rotated 90 degrees to be used for tracking the card use. There may or may not be a “mag stripe”. In the electronic version, the offers on the back of the card may be shown as a scrollable electronic listing when the card is in display mode. The graphical elements may be arranged differently than described here, depending on the design needs of the media and the business graphical imagery objectives.

In an embodiment, the essential elements are the Continuous™ Gift Card label, at least on the front of the card, and the listing of products/services for which purchase values are being given.

The business or its marketing agent then creates a physical or electronic image of the Continuous Gift Card, in printed form on paper, plastic or other material, or in electronic image form. These “cards” are then distributed to selected consumers, via Direct Mail, Email, Web sites, physically handed out in-store, etc.

The card recipient pulls off, or removes the card at the perforation cuts or prints out the cards from a print image provided online, or pulls up a card image on a cell “smart” phone web image and takes the card into the business to be submitted as purchase value(s) applied against products or services purchased.

The business verifies that the product or service selected by the card user corresponds to the items currently valid and that the card and card number is valid. The purchase value is applied against the card user's purchases, according to the terms specified by the purchase value listed on the card and on the terms and conditions referred to by the card.

The card may include an indicia that is means for a user to discover more offers at a URL or website.

The present invention is not limited to physical printed or plastic cards or card images. For example, the invention applies to a physical plastic card about 2 inches by 3 inches or about the same aspect ratio, though of different size. It also applies to card images of this general description both print and electronic. It also applies to offers accessible through an Internet program, such as an “app.” Accordingly, this invention is intended to embrace all alternatives, modifications, and variations that fall within the spirit and broad scope of the claims.

What is claimed is:

1. A method for providing a gift card having a value to a user, the method comprising:
a) determining at least one product or service of a merchant to be included in an offer to the user;
b) determining terms for each product or service in the offer;
c) determining a value for each product or service in the offer;
d) determining whether to allow the user to use all of the products or services in the offer;
e) specifying a selection of the products or services in the offer available for user by the user;
f) aggregating the maximum total value of the offer;
g) preparing the card, the card comprising i) a listing of the products and services in the offer, ii) the selection of the products or services in the offer available for user, and iii) the maximum total value of the offer; and
h) sending the card to the user, wherein the user selects choices from the selection of the products or services in the offer up to the maximum total value of the offer.

2. The method of claim 1 wherein at least one of the products or services in the offer has a high value and the other products or services are one of new or lower value than the first product/service.

3. The method of claim 1 wherein the offer comprises a combination of products/services.

4. The method of claim 1 wherein the card contains offers from more than one merchant.

5. The method of claim 1 wherein the user is permitted to choose one product/service from the offer.

6. The method of claim 1 wherein the card is digital.

7. The method of claim 6 wherein the card comprises an electronic display.

8. The method of claim 7 wherein the display indicates a) a listing of products and services in the offer, and b) the aggregated value of the offer.

9. The method of claim 8 wherein, when the card is used, the aggregated value displayed is decreased by the value of the product/service selected by the user.

10. A gift card comprising i) a listing of products and services offered by a merchant under terms, ii) a selection of the products or services in the offer available to a user, and iii) a maximum total value of the offer; wherein a user, when using the card, selects choices from the selection of the products or services in the offer up to the maximum total value of the offer.

11. The card of claim 10 wherein at least one of the products or services in the offer has a high value and the other products or services are one of new or lower value than the first product/service.

12. The card of claim 10 wherein the offer comprises a combination of products/services.

13. The card of claim 10 wherein the card contains offers from more than one merchant.

14. The card of claim 10 wherein the user is permitted to choose one product /service from the offer.

15. The card of claim 10 wherein the card is digital.

16. The card of claim 15 wherein the card comprises an electronic display.

17. The card of claim 16 wherein the display indicates a) a listing of products and services in the offer, and b) the aggregated value of the offer.

18. The card of claim 17 wherein, when the card is used, the aggregated value displayed is decreased by the value of the product/service selected by the user.
